(19) United States
(12) Patent Application Publication
(10) Pub. No.: US 2025/0326338 A1
(43) Pub. Date: Oct. 23, 2025

(54) ROTATABLE CAR SEAT WITH LOCKING FEATURE

(71) Applicant: Evenflo Company, Inc., Miamisburg, OH (US)

(72) Inventors: Bryan Ray ADAMS, Beavercreek, OH (US); Eric Dahle, Ludlow Falls, OH (US); Xiang Gao, Kunshan City (CN); Youcai Zhang, Kunshan City (CN)

(21) Appl. No.: 18/643,542

(22) Filed: Apr. 23, 2024

(51) Int. Cl. B60N 2/28

(52) U.S. Cl. CPC B60N 2/2869; B60N 2/2821

(57) ABSTRACT

Embodiments of the present disclosure include a car seat comprising a base, a seat shell, and a lock that moves between a lock configuration in which the seat shell is rotatable but not removable from the base and an unlock configuration in which the seat shell is removable from the base. The lock may comprise engagement elements in the base that are received within an opening of the seat shell and are selectively moved to engage and disengage the seat shell. An actuator may be used to move the lock to an unlock configuration. Some embodiments include an opening to engage the actuator to be sized and shaped to receive the end of the tongue of a vehicle safety belt. Additionally, some embodiments include an actuator locking arm that keeps the actuator in an unlock position.

### BACKGROUND

In the United States, child car seats are required by law and recommended for children of certain ages or sizes. There are many types of car seats available for purchase. Infant car seats recommended for children under the age of one are typically rearward facing. Many infant car seats include a base that is belted or tethered into the car and a seat that may latch into the base. Some car seats, including rotatable car seats, have a seat shell that holds the child occupant and a base supporting the seat shell, where the seat shell may be removed from the base to reach particular areas of the base and/or seat shell, such as to reach the belt path, belt tensioner (e.g., strong arm), or tethers to connect the car seat to a vehicle seat.

### BRIEF DESCRIPTION OF THE DRAWINGS

The foregoing and other features of the present disclosure will become more fully apparent from the following description and appended claims, taken in conjunction with the accompanying drawings. Understanding that these drawings depict several examples in accordance with the disclosure and are, therefore, not to be considered limiting of its scope, the disclosure is described with additional specificity and detail below through the use of the accompanying drawings.

FIGS. 1A, 1B, and 1C are a perspective view, a front view, and a side view, respectively, of a car seat in a forward-facing position in accordance with an embodiment disclosed herein;

FIGS. 2A and 2B are perspective views of the car seat of FIG. 1 in a rearward-facing position and in an intermediate position, respectively, in accordance with an embodiment disclosed herein;

FIGS. 3A and 3B are a perspective view and a bottom view, respectively, of a seat shell of the car seat of FIG. 1 in accordance with an embodiment disclosed herein;

FIGS. 4A and 4B are a side view and a perspective view, respectively, of a base of the car seat of FIG. 1 in accordance with an embodiment disclosed herein;

FIG. 5 is a perspective view of the base of FIGS. 4A and 4B with a strong arm in an open position in accordance with an embodiment disclosed herein;

FIG. 6 is an exploded view of the car seat of FIG. 1 in accordance with an embodiment disclosed herein;

FIGS. 7A and 7B are close-up cross-sectional views of the car seat of FIG. 1 with the locking features in a locked configuration and an unlocked configuration, respectively, in accordance with an embodiment disclosed herein;

FIG. 8 is a perspective view of the base of FIGS. 4A and 4B with parts removed to show internal structures in accordance with an embodiment disclosed herein;

FIG. 9 is a close-up perspective view of the base of FIGS. 4A and 4B with additional parts removed to show the locking structures in accordance with an embodiment disclosed herein;

FIG. 10 is a close-up front view of the base of FIGS. 4A and 4B in accordance with an embodiment disclosed herein;

FIGS. 11A and 11B are close-up perspective views of the base of FIGS. 4A and 4B with parts removed to show an example actuator locking mechanism in an unlocked configuration and a locked configuration, respectively, in accordance with an embodiment disclosed herein; and

FIG. 12 is a close-up cross-sectional view of the car seat of FIG. 1 with the actuator locking mechanism in a locked configuration in accordance with an embodiment disclosed herein.

### DETAILED DESCRIPTION

In the following detailed description, reference is made to the accompanying drawings, which form a part hereof. In the drawings, similar symbols identify similar components, unless context dictates otherwise. The illustrative examples described in the detailed description and drawings are not meant to be limiting and are for explanatory purposes. Other examples may be utilized, and other changes may be made, without departing from the spirit or scope of the subject matter presented herein. It will be readily understood that the aspects of the present disclosure, as generally described herein and illustrated in the drawings, may be arranged, substituted, combined, and designed in a wide variety of different configurations, each of which are explicitly contemplated and form a part of this disclosure.

It should be noted that some of the terms used herein may be relative terms. For example, the terms “upper” and “lower” and the terms “forward” (or “front”) and “rearward” (or “back”) are relative to each other in location, i.e., an upper component is located at a higher elevation than a lower component in a given orientation, but these terms may change if the device is flipped. An intermediate component, on the other hand, is always located between an upper component and a lower component regardless of orientation. The terms “horizontal” and “vertical” are used to indicate direction relative to an absolute reference, i.e., ground level. However, these terms should not be construed to require structures to be absolutely parallel or absolutely perpendicular to each other. For example, a first vertical structure and a second vertical structure are not necessarily parallel to each other. The terms “top” and “bottom” are used to refer to surfaces where the top is always higher than the bottom relative to an absolute reference, i.e. the surface of the earth when the component is used as intended. The terms “upwards” or “upwardly” and “downwards” or “downwardly” are also relative to an absolute reference; upwards is always against the gravity of the earth. The terms “forward” and “rearward” or “rear” with respect to a position or orientation are opposite one another along a common direction, and an “intermediate” position is always located between a forward position and a rearward position.

The terms “operative to” and “configured to” and similar terms are used herein to describe that a particular component has certain structural features designed to perform a designated function. Such components should be construed as having the expressed structure, with the designated function being considered part of the structure. The term “engage” and similar terms are used herein to describe the interaction between particular components and do not necessarily require that such components contact one another (directly or indirectly). As used herein and as will be appreciated by those skilled in the art, the term “car seat” encompasses car seats, safety seats, restraints, boosters, and the like for children, infants, toddlers, and the like.

Unless indicated otherwise, all measurements provided herein are taken when a component(s) is at standard ambient temperature and pressure (298.15 K and 100 kPa). As used herein, the terms “substantially” and “about” mean within +5% of an indicated value.

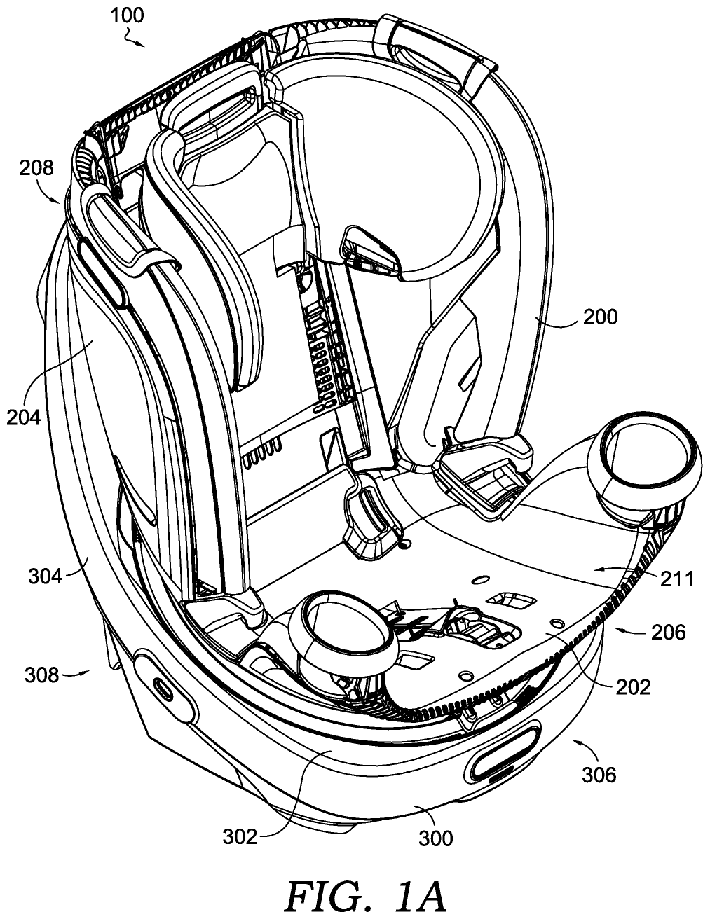

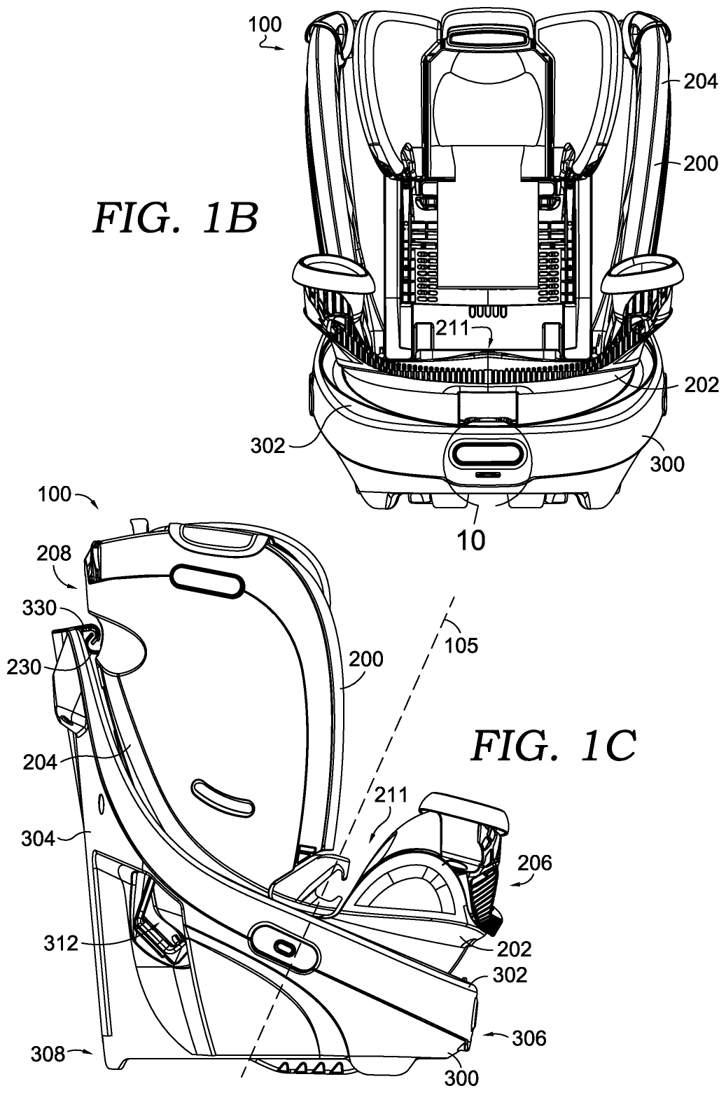

In accordance with aspects of the disclosure, exemplary embodiments of car seats are illustrated in various levels of specificity in FIGS. 1A-12. As will be appreciated by those skilled in the art, the car seats described herein may be convertible car seats that are convertible between at least two configurations. For example, a car seat described herein may be convertible between a forward-facing configuration and a rearward-facing configuration. In another example, a car seat described herein is convertible between a forward-facing configuration, a rearward-facing configuration, and a booster configuration. In yet another example, a car seat described herein is convertible between a forward-facing configuration and a rearward-facing configuration, a high-back booster configuration, and a backless booster configuration. The car seats of the present disclosure may be configured to support an infant, child, toddler, or the like.

Very generally, FIGS. 1A, 1B, and 1C depict a car seat 100 designed for safely transporting an infant or child in a vehicle, such as a car. The car seat 100 generally includes a seat shell 200 and a base 300 that supports the seat shell 200 in a vehicle. The car seat 100 (and, namely, the base 300) may be affixed to the seat of a vehicle, such as by a vehicle belt (e.g., lap belt) extending through a belt path 312 (see FIG. 1C). The seat shell 200 may include a forward end 206 and a rear end 208 opposite the forward end 206. The base 300 may also include a forward end 306 and a rear end 308 opposite the forward end 306.

As described in greater detail herein, embodiments of the seat shell 200 may be rotatable relative to the base 300. In this way, the seat shell 200 may be rotated to be selectively positionable in a variety of different positions (e.g., a rearward-facing position, a forward-facing position, an intermediate loading position) when installed in a vehicle. In particular, the seat shell 200 may rotate about an axis 105 that may be generally vertical. In some examples, including the one shown in FIG. 1C, the axis 105 is generally vertically while on a slight diagonal such that the angle of the seat shell 200 relative to the vehicle seat may change as the seat shell 200 is rotated about the axis 105 between forward-facing and rearward-facing positions.

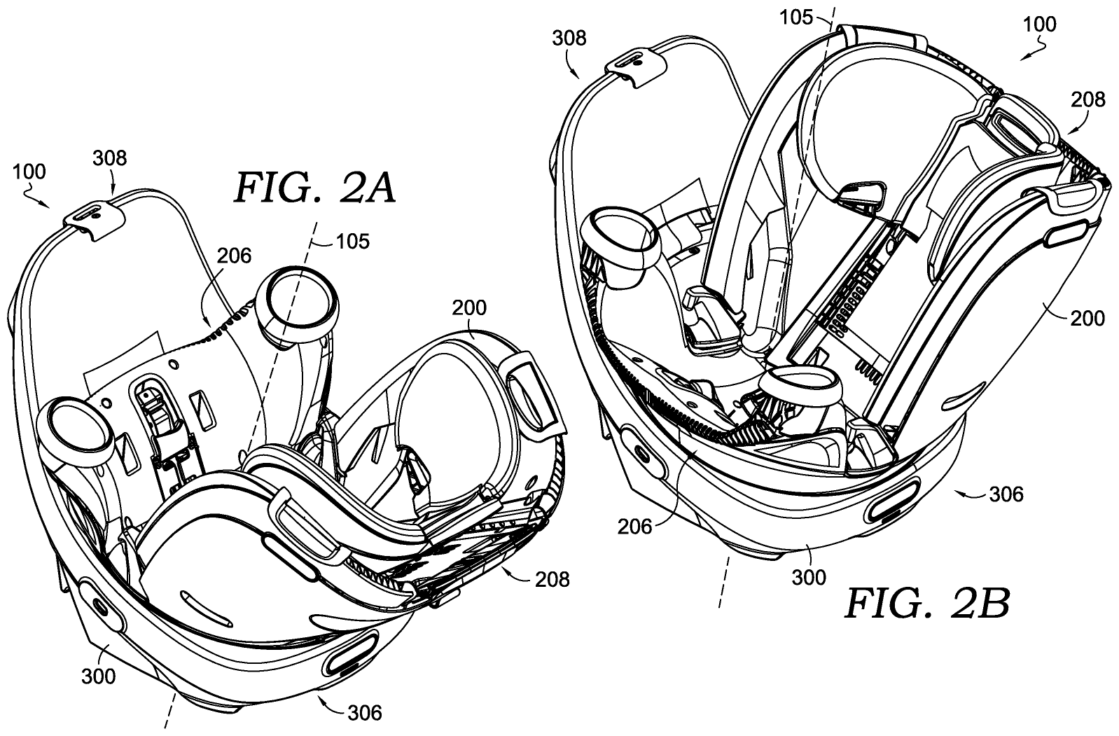

FIGS. 1A-C, for example, illustrate the seat shell 200 supported on the base 300 in a forward-facing position. With reference to FIG. 1C, in the forward-facing position, a forward end 206 of the seat shell 200 and a forward end 306 of the base 300 face a common direction (e.g., toward the forward end of the vehicle when installed), and a rear end 208 of the seat shell 200 and a rear end 308 of the base 300 face a common direction (e.g., toward the rear end of the vehicle when installed). FIG. 2A depicts the seat shell 200 supported on the base 300 in a rearward-facing position. As can be readily understood with reference back to FIG. 1C, the seat shell 200 is rotated with respect to the base 300 about 180 degrees between the forward-facing position and the rearward-facing position. As such, in the rearward-facing position, a forward end 206 of the seat shell 200 and a rear end 308 of the base 300 face a common direction (e.g., toward the rear end of the vehicle when installed), and a rear end 208 of the seat shell 200 and a forward end 306 of the base 300 face a common direction (e.g., toward the front end of the vehicle when installed).

FIG. 2B depicts the seat shell 200 in an intermediate position as it is rotated between the forward-facing position in FIG. 1C and the rearward-facing position in FIG. 2A. In the intermediate position, the forward end 206 of the seat shell 200 faces a direction between the forward end 306 of the base 300 and the rear end 308 of the base 300 (e.g., such that, when installed, the forward end 306 of the seat shell 200 is toward a vehicle side door between the forward and rear ends of the vehicle).

As may now be appreciated, the seat shell 200 may be rotated with respect to the base 300 between the forward-facing position and the rearward-facing position as the base 300 remains installed and stationary in the vehicle. Further yet, the seat shell 200 may be rotated any desired amount with respect to the base 300 (including being rotated a full 360 degrees). As may further be appreciated, the seat shell 200 is rotatable with respect to the base 300 to a variety of intermediate positions between the forward-facing position and the rearward-facing position. It is specifically contemplated that the seat shell 200 may be rotatable, with respect to the base 300, about 90 degrees in both a clockwise direction and a counterclockwise direction to intermediate positions. In this way, the car seat 100 is operable to be usable on either the driver's side or passenger's side of a vehicle and equally provides ease for a user to place a child into the car seat 100 while the seat shell 200 generally faces the adjacent vehicle side door before the seat shell 200 is rotated to a forward-facing or rearward-facing position.

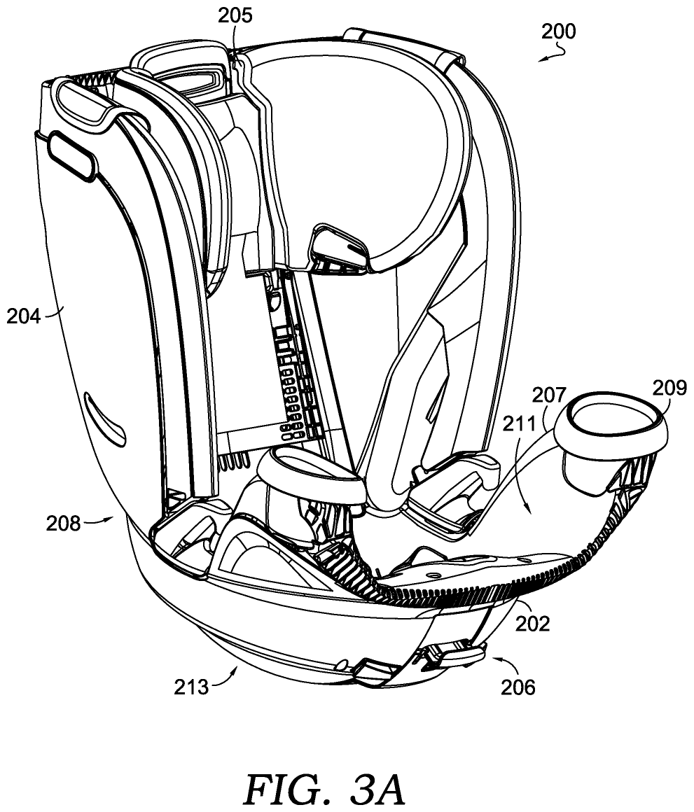

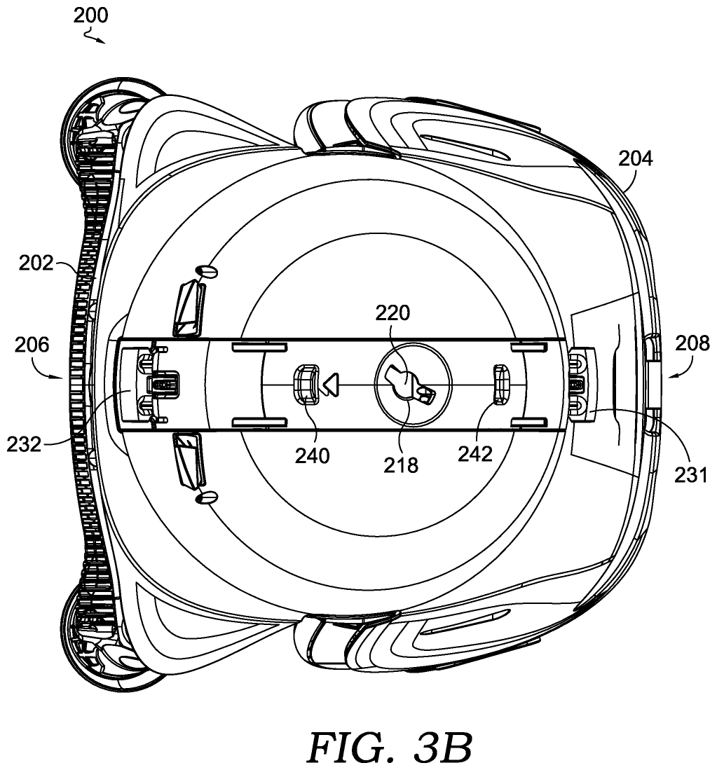

FIGS. 3A and 3B illustrate views of the seat shell 200 without the base 300. The seat shell 200 includes a seat bottom 202 and a seat back 204. The seat bottom 202 of the seat shell 200 may generally operate as a seating surface for the occupant by supporting and stabilizing the seat of the occupant. For example, an occupant may be seated on a top side 211 of the seat bottom 202 of the seat shell 200. The seat back 204 may extend upwardly away from the seat bottom 202, such as extending upwardly from the seat bottom 202 proximate the rear end 208 of the seat shell 200.

The seat shell 200 may include a headrest 205 configured to support the occupant's head. In some aspects, the headrest 205 may be adjustable along the length of the seat back 204 to safely accommodate occupants of different heights. Additionally, the seat shell 200 may include armrests 207 extending upward from the right and left sides of the seat bottom 202. In some aspects, one or both armrests 207 include a cup holder 209, which may be removable from the armrest 207.

Although not shown, it should be understood that the seat shell 200 may include softgoods (e.g., textile coverings and/or cushions) extending over the top side 211 of the seat bottom 202 and along the front of the seat back 204 and the headrest 205. Additionally, the seat shell 200 may include one or more belts, such as shoulder and thigh belts and a crotch belt connected with a five-point harness, to secure an occupant safely within the seat shell 200.

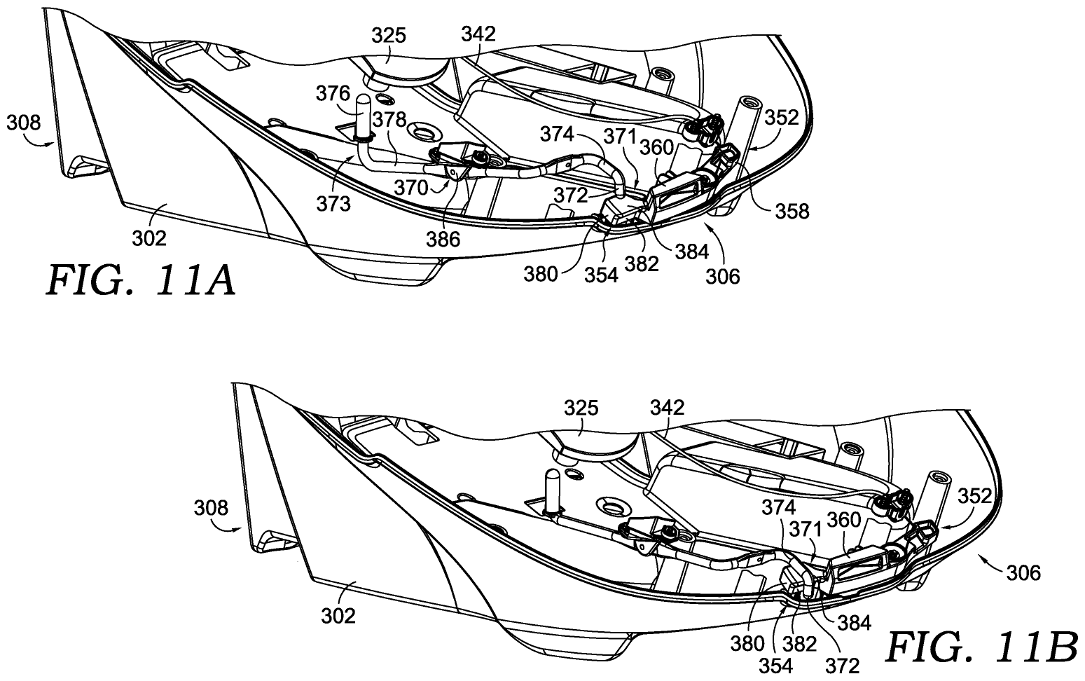

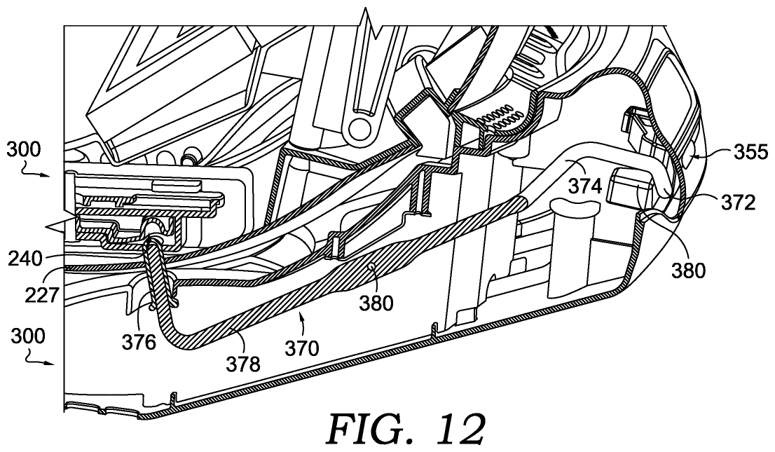

A bottom side 213 of the seat bottom 202 may have a hemispherical shape that sits within a cavity of the base 300 as described further herein. The bottom side 213 of the seat bottom 202 may also include an opening 220 configured to receive a locking structure on the base 300 as described further herein. In some aspects, the bottom side 213 of the seat bottom 202 may further include recesses 240 and 242 for receiving an actuator locking structure as further described with respect to FIGS. 11A-12.

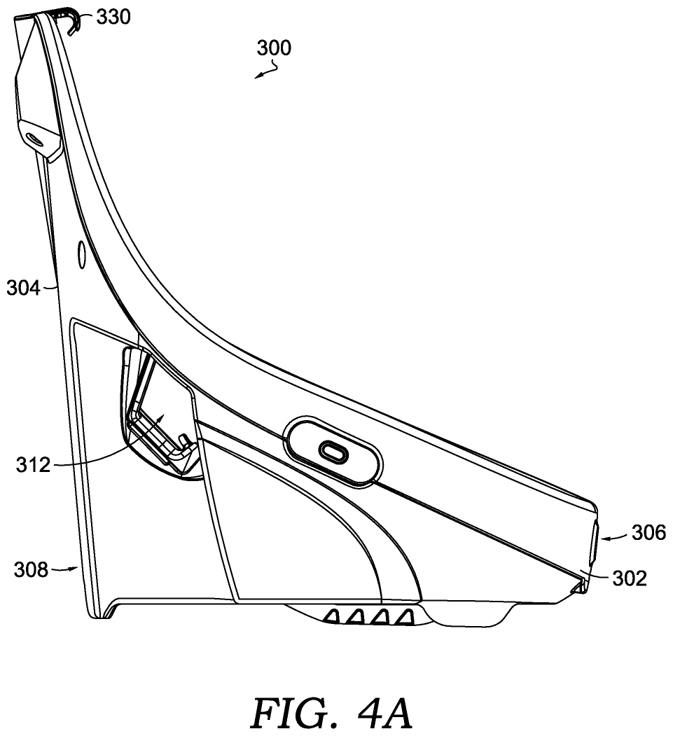

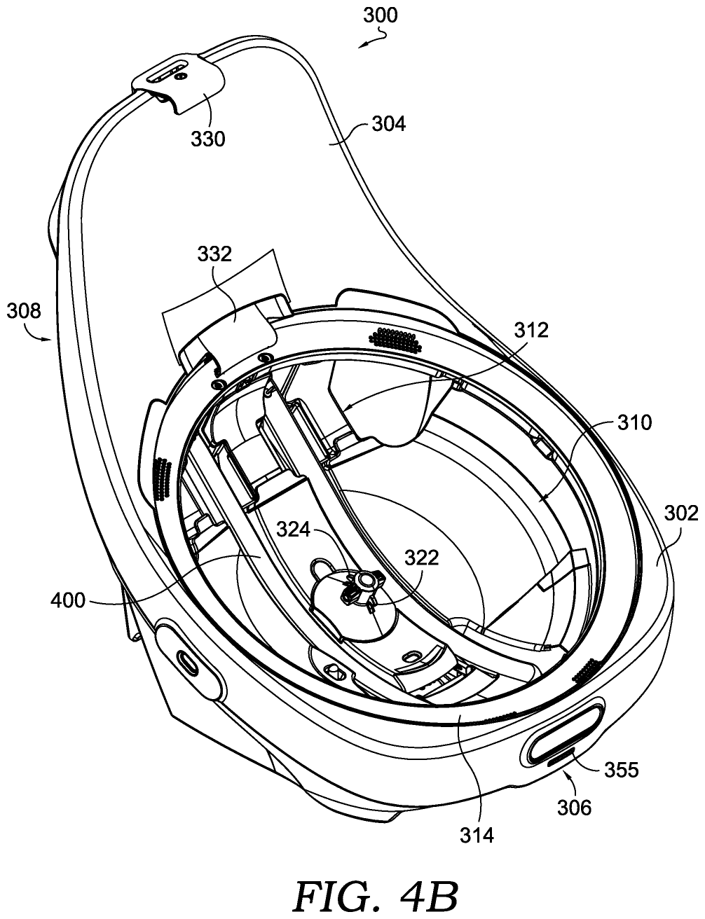

Turning to FIGS. 4A and 4B, views of the base 300 without the seat shell 200 are provided. The base 300 is configured to support and stabilize the seat shell 200. In particular, the base 300 includes a receiving portion 302 that generally operates to support the seat shell 200 on the base 300, which may be supported on a seat of a vehicle. It is contemplated that the base 300 may comprise a single structure or multiple structures that are secured together so that such multiple components could not be uncoupled by a user. However, it is also contemplated that the term “base” used herein may include the combination of a base structure configured to sit on the seat of a vehicle and an intermediate structure that may be configured to be selectively removed from the base structure by a user.

In some aspects, the base 300 also includes a backing portion 304 that extends upwardly away from the receiving portion 302 proximate the rear end 308 of the base 300. The backing portion 304 may assist in supporting the seat back 204 when the seat shell 200 is installed within the base.

Some embodiments of the base 300 include a strong arm 400 intended to clamp or tension a tether or belt extending through the base 300 so that the base 300 may be securely installed in a vehicle seat. In particular, the base 300 may include a belt path 312 extending between right and left sides of the base 300. A proximal end of strong arm 400 may be pivotally connected to the base 300 on one side of the belt path 312, while a distal end may be releasably secured to the receiving portion 302 of the base 300 on another side of the belt path 312 such that the strong arm 400 may extend across the belt path 312. In one example, the strong arm 400 may be pivotally connected to the base 300 proximate the rear end 308 of the base 300.

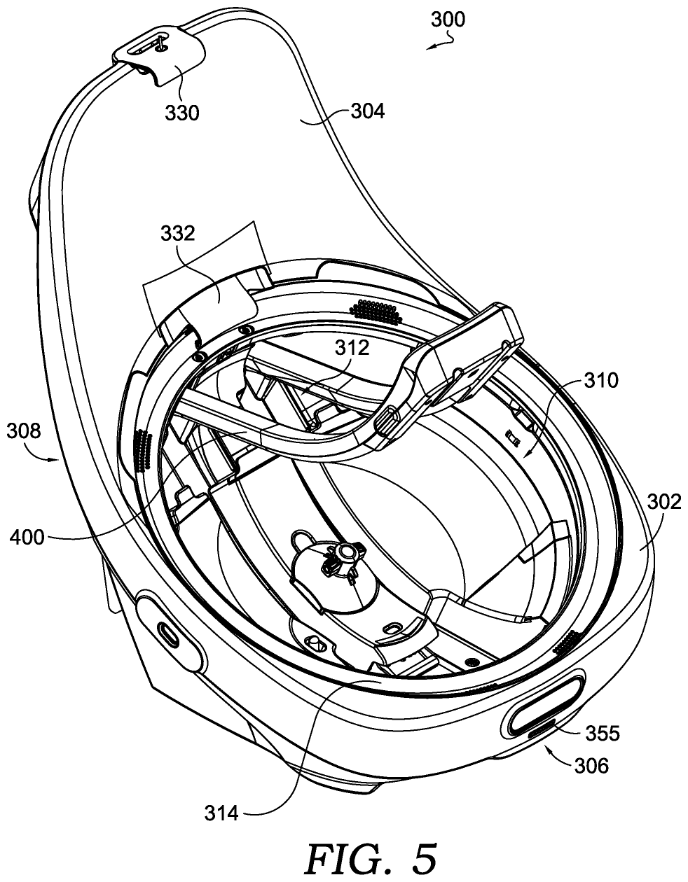

As the strong arm 400 is pivoted, a distal end of the strong arm 400 may be moved toward and away from the base 300 (and, more particularly, toward and away from the belt path 312). FIG. 4B depicts the strong arm 400 in a closed (or locked) position so that the distal end of the strong arm 400 is secured to the base 300, which would tension or clamp down any tether (including a vehicle belt) extending through the belt path 312. FIG. 5 depicts the strong arm 400 in an open (or unlocked) position where the distal end of the strong arm 400 is unsecured from the base 300, which would allow a user to thread a tether through the belt path 312 for installation or remove a tether for uninstallation. In alternative embodiments, the strong arm 400 may also be slidably movable with respect to the base 300 such that the strong arm 400 is slidable into and out of the base 300. The strong arm 400 may be slidable into and out of the base 300 in a direction substantially perpendicular to the belt path 312.

At least a portion of the seat shell 200 may be received by and/or within the receiving portion 302 of the base 300. Put another way, the receiving portion 302 of the base 300 may be configured to interface with at least a portion of the seat shell 200. More specifically, the receiving portion 302 may include a receiving cavity 310 that receives the hemispherical bottom side 213 of the seat bottom 202 of the seat shell 200.

Further, the receiving portion 302 of the base 300 may include a support ledge 314 along at least a portion of the perimeter of the receiving cavity 310. The support ledge 314 may generally operate as a surface that abuts a bottom surface of the seat bottom 202 of the seat shell 200 when the seat shell 200 is positioned within the receiving cavity 310. Further, aspects of the seat shell 200 may be configured to rotate relative to the base 300 while the seat shell 200 is retained by the receiving portion 302, and the support ledge 314 may provide a surface along which the seat shell 200 travels as the seat shell 200 is rotated with respect to the base 300, as described in detail herein. In this way, the support ledge 314 may be viewed as a track along which the seat shell 200 rotates. As can be appreciated, the support ledge 314 may be an arcuate track. More specifically, in some embodiments, the support ledge 314 is circular in shape and may define an opening to the receiving cavity 310 of the base 300. The support ledge 314 may extend continuously around the perimeter of the receiving cavity 310 or may be formed from a plurality of discontinuous segments. Additionally, the support ledge 314 may be positioned radially inward of an outer edge of the receiving portion 302 of the base 300.

The receiving portion 302 of the base 300 may include one or more retainment features, including different types of retainment features, that couple the seat shell 200 to the base 300. For example, the base 300 may include a plurality of receiving features that form a slot or groove for receiving peripheral portions of the seat shell 200 while still permitting rotation. In some examples, an upper receiving feature 330 is positioned on the backing portion 304 of the base 300 proximate an upper edge of the backing portion 304, and a lower receiving feature 332 is positioned within the receiving portion 302 of the base 300 proximate the rear end 308 of the base 300. The lower receiving feature 332 may be positioned proximate where the backing portion 304 of the base 300 meets the receiving portion 302. Additionally, the upper receiving feature 330 generally may be vertically aligned with the lower receiving feature 332 such that the upper receiving feature 330 is positioned above the lower receiving feature 332.

The upper receiving feature 330 and/or the lower receiving feature 332 on the base 300 may receive a corresponding feature of the seat shell 200 to help retain the seat shell 200 on the base 300 in a forward-facing orientation (e.g., FIGS. 1A-C) or a rearward-facing orientation (e.g., FIG. 2A). For example, turning back to FIG. 1C, the seat shell 200 may include an upper engagement feature 230 that can be received in or otherwise engaged with the upper receiving feature 330 of the base 300 when the seat shell 200 is in a forward-facing orientation. Additionally, as seen in FIG. 3B, the seat shell 200 may also include a first lower engagement feature 231 positioned proximate the rear end 208 of the seat shell 200. In particular, the first lower engagement feature 231 may be positioned proximate the location where the seat back 204 meets the seat bottom 202 of the seat shell 200. The first lower engagement feature 231 may be received in or otherwise engaged with the lower receiving feature 332 on the base 300 when the seat shell 200 is in a forward-facing orientation. Further, the seat shell 200 may include a second lower engagement feature 232 positioned proximate the forward end 206 of the seat shell 200 on the seat bottom 202. When the seat shell 200 is in a rearward-facing orientation, the second lower engagement feature 232, instead of the first lower engagement feature 231, may be received in or otherwise engaged with the lower receiving feature 332 of the base 300, and the upper receiving feature 330 of the base 300 may not be engaged with the seat shell 200. When the seat shell 200 is rotated out of a forward-facing or rear-facing orientation (such as when the seat shell 200 is in an intermediate orientation as shown in FIG. 2B), the upper receiving feature 330 and the lower receiving feature 332 may both be disengaged with the seat shell 200.

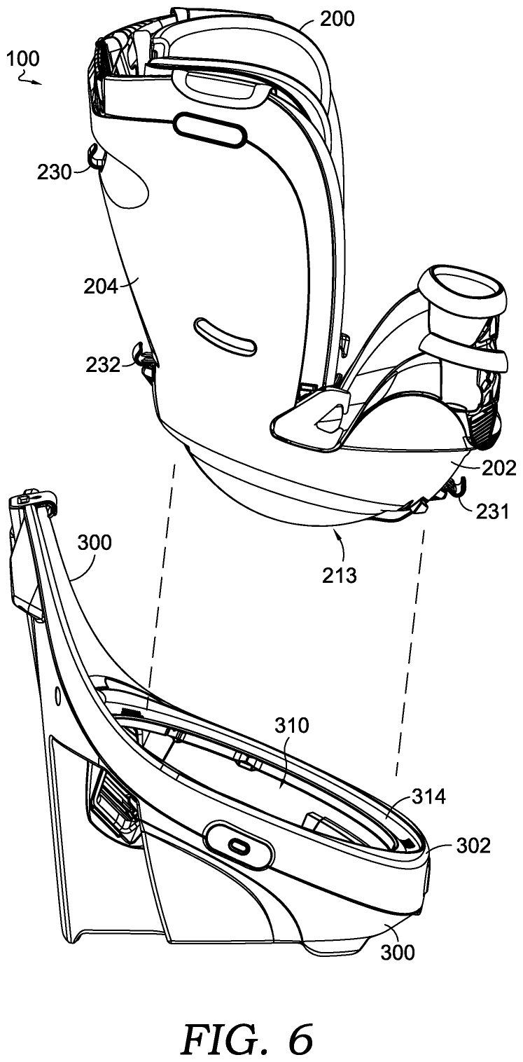

By way of a non-limiting example, the upper receiving feature 330 and the lower receiving feature 332 are both downward-facing hooks, and the upper engagement feature 230, the first lower engagement feature 231, and the second lower engagement feature 232 are all upper-facing hooks. FIG. 6 depicts an exploded view with the seat shell 200 removed from the base 300 and illustrates this embodiment of the engagement features 230, 231, and 232. In other examples, the seat shell 200 may have receiving features that form a slot or groove for receiving engagement features on the base 300.

Additionally, embodiments of the base 300 include a centrally positioned projection 320. The projection 320 extends upwards from an inner surface of the receiving portion 302 of the base 300. The projection 320 is at least partially received within the opening 220 on the bottom side 213 of the seat bottom 202 when the seat shell 200 is positioned within the receiving cavity 310 of the base 300. The opening 220 may be centrally positioned on the hemispherical bottom side 213 of the seat bottom 202. The axis 105 along which the seat shell 200 rotates aligns with the projection 320 such that the seat shell 200 may rotate around the projection 320 as the seat shell 200 moves between forward-facing and rearward-facing orientations as described herein.

Additionally, as can be best seen in FIGS. 4B and 5, the strong arm 400 may be generally U-shaped, although embodiments of the present disclosure are not so limited and the strong arm 400 may be of any suitable size and shape. When the strong arm 400 is in the closed position, as shown in FIG. 4B, the strong arm 400 may lie about (e.g., around) the projection 320. More specifically, in certain constructions, the strong arm 400 may lie within a recessed portion in an inner surface of the receiving portion 302 of the base 300. In this way, the strong arm 400 does not interfere with rotation of the seat shell 200 with respect to the base 300 as described in detail herein.

To access the strong arm 400 for installation and de-installation of the base 300 on a vehicle seat, the seat shell 200 may need to be removed from the base 300. As such, the seat shell 200 is removably coupled to the base 300 such that the seat shell 200 may be selectively removed from the base 300 when desired. Such removable detachment may also allow for easier transportation of the car seat 100 when it is not in use, such as during shipping. In this way, the seat shell 200 being completely removable from the base 300 for easier access to installation parts may ensure a more secure and safer installation as well as provide a better user experience and allow for easier shipping of the car seat 100; however, additional securement mechanisms between the seat shell and the base may ensure the seat shell 200 is not accidently or unknowingly unsecured from the base 300 during times of use.

As previously described, the seat shell 200 may be secured to the base 300 via the receiving features 330 and 332 and the engagement features 230, 231, and 232 when such features are aligned as the seat shell 200 is rotated in the forward-facing or rearward-facing positions. It may be further desirable, however, to maintain an additional point of attachment between the seat shell 200 and the base 300 even when the seat shell 200 is rotated to an intermediate position (e.g., FIG. 2B) while such a point of attachment may still allow for selective disengagement from the user to remove the seat shell 200 from the base 300 for accessing internal structures, such as the strong arm 400, and/or for disassembly of the car seat 100.

As such, the base 300 may include an additional retainment mechanism, including a movable locking structure. More specifically, the base 300 may include one or more locking members that move between a locked position and an unlocked position without rotation of the seat shell 200 relative to the base 300. In this way, the locking members may move between locked and unlocked positions via an actuator that is actuated by user action. Additionally, the locking members of the base 300 may be proximate the axis 105 of rotation, such that the locking members may be positioned within a central area of the receiving portion 302 of the base 300 so that the seat shell 200 may be rotated while the locking members of the base 300 are engaged with the seat shell 200 as further described herein.

Example locking members include a first hook 322 and a second hook 324. The first and second hooks 322 and 324 may be formed in the sides of the projection 320. When the projection 320 is received within the opening 220 of the seat shell 200, both the first hook 322 and the second hook 324 may at least partially extend within the opening 220. In this way, both locking members (the first hook 322 and the second hook 324) are received within a single opening 220 in the seat shell 200 together. The opening 220 in the seat shell 200 that receives the locking members, such as the first hook 322 and the second hook 324, for locking the seat shell 200 to the base 300 may also be referred to herein as a lock opening. In some aspects, the base 300 includes only one hook that engages with the lock opening 220 of the seat shell 200. Although the illustrated examples of locking members are hooks, it should be appreciated that other examples of locking members may include other structures, including structures that move in a different way. For example, the locking members on the base 300 may be pins, rods, or tabs that slide vertically, horizontally, or diagonally.

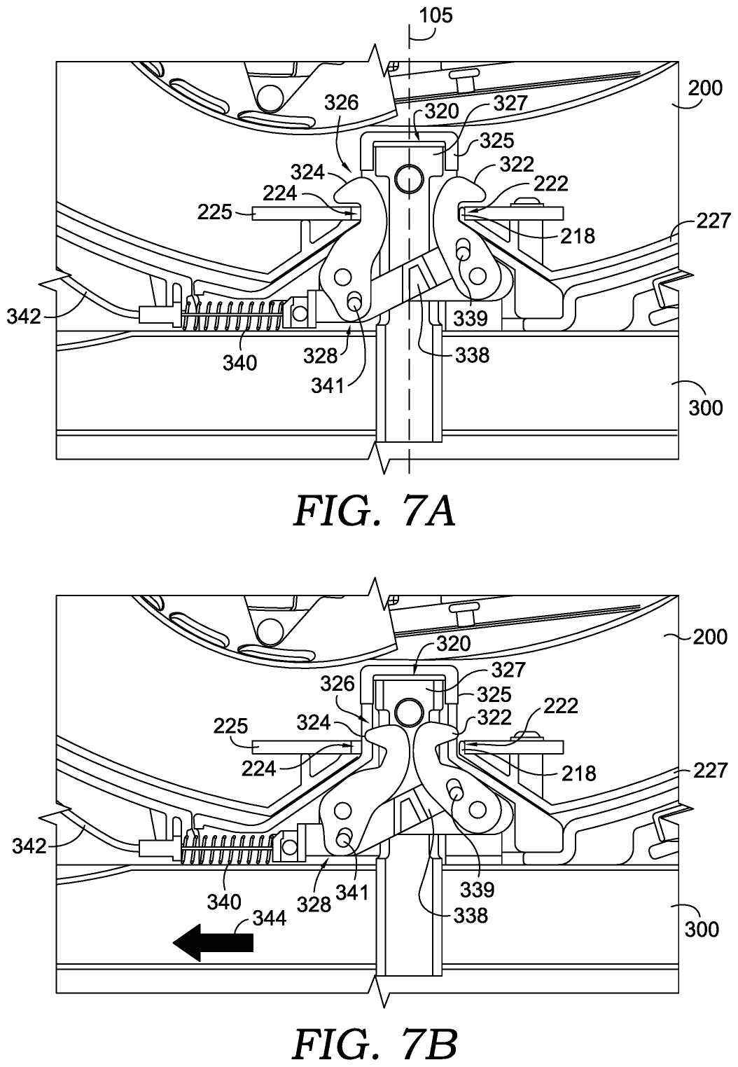

FIGS. 7A and 7B provide close-up cross-sectional views of the locking members of the base 300 in a locked configuration (FIG. 7A) and an unlocked configuration (FIG. 7B). The locking members (e.g., the first hook 322 and the second hook 324) are both pivotally secured within the receiving portion 302 of the base 300. In particular, each hook 322 and 324 has a proximate end 328 that is pivotally secured with another structure in the base 300 and a distal end 326 that engages with seat shell 200. For clarity, the distal end 326 and proximate end 328 have been labeled on only the second hook 324 in FIGS. 7A and 7B, but it should be understood that the first hook 322 has the same distal and proximate ends.

The projection 320 includes a central post 327 and the first and second hooks 322 and 324, where the first and second hooks 322 and 324 face away from the central post 327. The seat shell 200 forms a lock edge 218 that defines the lock opening 220. When the first hook 322 and the second hook 324 are engaged with the seat shell 200 to lock the seat shell 200 with the base 300, the first hook 322 and the second hook 324 may each be engaging with a portion of the lock edge 218. As depicted, the first hook 322 and the second hook 324 may generally face away from each other such that, when received within the lock opening 220, the first hook 322 and the second hook 324 may be faced towards opposite portions of the lock edge 218. For example, the first hook 322 will engage with a first portion 222 of the lock edge 218, and the second hook 324 will engage with a second portion 224 of the lock edge 218. The first portion 222 may be opposite the second portion 224. Additionally, in some aspects, the lock edge 218 may be defined by an outer seat shell 227 (e.g., the component forming the exterior surface of the bottom side 213 of the seat shell 200) and a reinforcing plate 225 positioned interior to the outer seat shell 227. The reinforcing plate 225 may strengthen the integrity of the seat shell 200 at the point of engagement with the base 300 to reduce wear and tear and maintain a secure attachment.

Returning to the base 300, the projection 320 within the receiving cavity 310 may further include an arm 338 configured to cause the first and second hooks 322 and 324 to move between locked and unlocked configurations. In various embodiments, the arm 338 is secured to the first hook 322 with a first pin 339 and to the second hook 324 with a second pin 341. The arm 338 may be secured to the second hook 324 at a location adjacent the proximate end 328 and secured to the first hook 322 at a location further away from the proximate end 328 in comparison to the second hook 324. For example, the arm 338 may be secured to the first hook 322 at a central location of the first hook 322 or proximate the hook structure at the distal end 326. A cable 342 or other linkage structure may be used to pull one end of the arm 338 in direction of the arrow 344 (away from the central post 327), which in turn pulls on the first and second hooks 322. The tension or pull applied to the first and second hooks 322 and 324 via the arm 338 can disengage both hooks 322 and 324 with the same movement even though the hooks 322 and 324 are oriented in different directions. For example, tension applied by pulling the arm 338 away from the central post 327 pulls at a more distal portion of the first hook 322, which causes the distal end 326 of the first hook 322 to pivot away towards the arm 338 (and away from the lock edge 218 on the seat shell 200), and tension applied by pulling the arm 338 away from the central post 327 pulls at a more proximate portion of the second hook 324, which causes the distal end 326 of the second hook 324 to pivot away from the arm 338 (and away from the lock edge 218 on the seat shell 200).

As described further herein, tension may be applied to the cable 342 to unlock the first and second hooks 322 and 324 via an actuator. Additionally, as shown in FIGS. 7A and 7B, the cable 342 may be secured to the arm 338. When tension is applied to the cable 342 (i.e., pulling), the arm 338 may be moved. Additionally, a biasing element, such as a coil spring 340, may be attached to the arm 338. When the arm 338 moves in the direction of arrow 344, the coil spring 340 may be compressed, and when tension is removed or reduced beyond a minimum threshold, the coil spring 340 may move towards its uncompressed state and cause the arm 338 to move back (i.e., in the direction opposite the arrow 344) so that the first and second hooks 322 and 324 return to the locked position.

Further, in some aspects, the projection 320 includes a housing 325 that contains the central post 327, the arm 338, and at least part of the first and second hooks 322 and 324. The distal ends 326 of the first and second hooks 322 and 324 (i.e., the parts that engage with the seat shell 200) may extend through openings in the housing 325. The housing 325 may also contain at least part of the coil spring 340.

The central post 327 of the projection 320 may generally align with the rotation axis 105 around which the seat shell 200 rotates while on the base 300. The projection 320, including the first and second hooks 322 and 324, will remain stationary while the seat shell 200 is rotated. The engagement between the first and second hooks 322 and 324 and the seat shell 200 (i.e., the lock edge 218 of the seat shell 200) may be such that the lock edge 218 may slide relative to the stationary hooks 322 and 324 so that the seat shell 200 may be rotated while the first and second hooks 322 and 324 are engaged and in a locked positioned. At the same time, the first and second hooks 322 and 324 prevent the seat shell 200 from being removed from the base 300 when the first and second hooks 322 and 324 are in the locked position regardless of the rotation position of the seat shell 200.

The locking features (e.g., the first and second hooks 322 and 324) of the base 300 may be selectively moved between the locked position (FIG. 7A) and the unlocked position (FIG. 7B) via an actuator 350. Example aspects of the actuator 350 are positioned at the forward end 306 of the receiving portion 302 of the base 300, but it should be understood that in other aspects, the actuator 350 may be positioned at the right or left sides or at the rear end 308. In the embodiments illustrated, the actuator 350 is a press button, but in other examples, the actuator 350 may be a rotatable key or a pull handle.

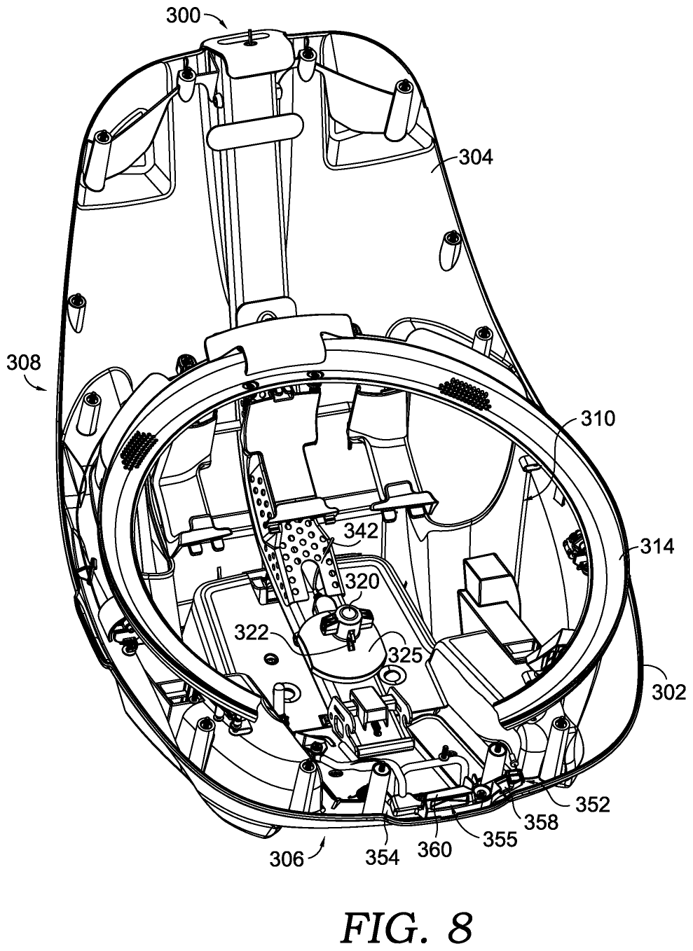

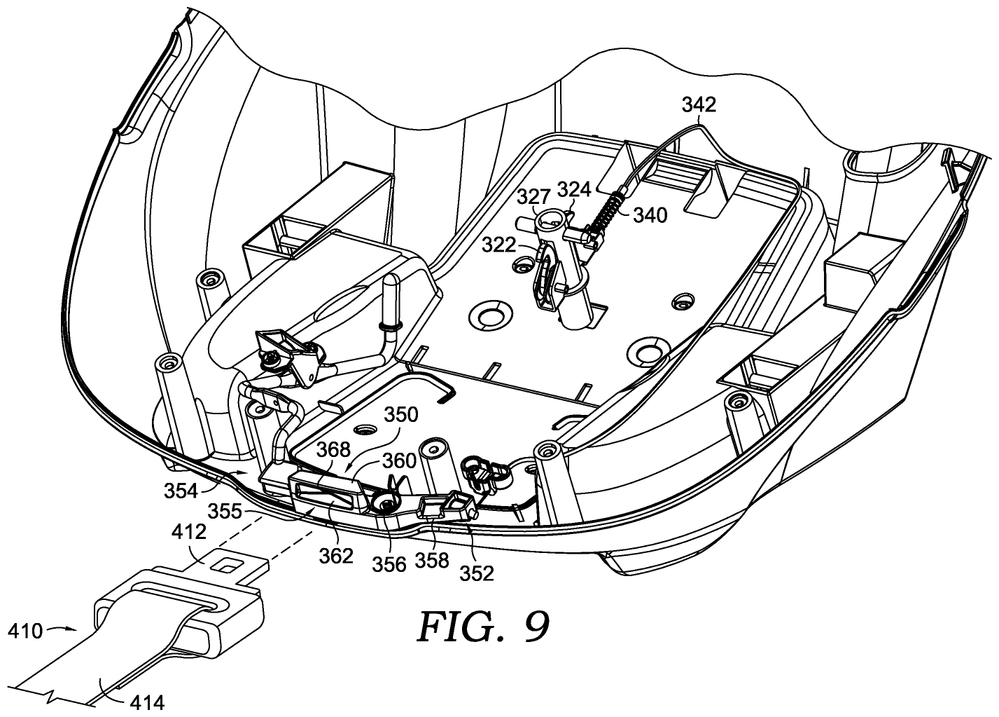

As previously stated, a connector, such as cable 342, may connect the locking mechanism to the actuator 350. For example, the cable 342 connects the actuator 350 to the arm 338, and the arm 338 is in turn connected to the first and second hooks 322 and 324. FIGS. 8 and 9 provide different close-up views of the base 300 to show the actuator 350 and how it is connected to the locking mechanism at the central projection 320. For example, FIG. 8 provides a view with, among others, some external coverings, the strong arm 400, and part of the support ledge 314 removed, and FIG. 9 provides a view with the entire support ledge 314 and the projection housing 325 also removed. As shown in FIGS. 8 and 9, the cable 342 is routed from the projection 320 at a central location within the receiving portion 302 towards the forward end 306 of the receiving portion 302 so that forces applied to the actuator 350 at the forward end 306 may be used to move the first and second hooks 322 and 324. The cable 342 may be a single, continuous cable, but it is contemplated that in other aspects, the cable 342 may be a series of connecting features (e.g., flexible cables or more rigid rods) joined together between the projection 320 and the actuator 350.

Examples of the actuator 350 include an actuating portion that is configured to be interacted with by a user, and a transferring portion that is configured to transfer the force caused by user interaction to the connector cable 342. In the embodiment depicted, the actuator 350 includes a press portion 360 on which the user applies a pressing force, and an arm 358 that pulls on the cable 342 in response to the pressing force applied to the press portion 360. In particular, the actuator 350 may be a pivoting piece that includes a pivot point 356 between the press portion 360 and the arm 358, so that when the press portion 360 is pressed inward, away from the forward end 306, as described further herein, the arm 358 on the opposite side of the pivot point 356 is pulled towards the forward end 306. The arm 358 is connected to the cable 342 so that pressing the press portion 360 away from the forward end 306 in turn causes the arm 358 to pull the cable 342 towards the forward end 306 and away from the projection 320. This movement of the cable 342 towards the forward end 306 causes the first and second hooks 322 and 324 to move to the locked position as described with respect to FIGS. 7A and 7B.

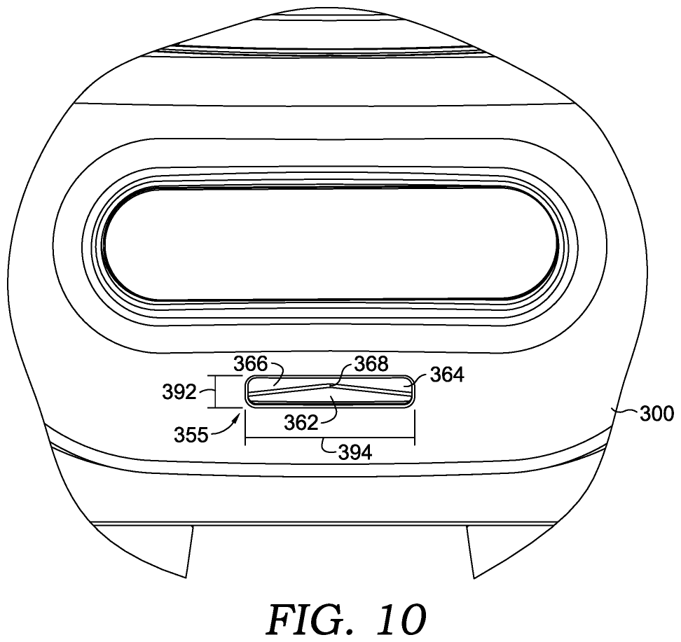

While parts of the actuator 350 remain within the base 300, at least part of the press portion 360 of the actuator 350 is exposed so that it may be acted upon by a user. As such, the base 300, and particularly an exterior surface of the base 300, includes an opening 355 through which part of the press portion 360 is exposed. FIG. 10 shows a close-up front view of the base 300 to show the opening 355.

In some aspects, it may be desirable to limit the size of the opening 355 so that a special tool may be required by a user to press on the actuator 350, which would prevent a user from accidentally engaging the actuator 350 at a time when it would be unsafe to unlock the seat shell 200 from the base 300. The opening 355 has a first dimension 392, which may be a height of the opening 355, and a second dimension 394, which may be the width of the opening 355. In some examples, the first dimension 392 is no greater than 10 millimeters. In one particular example, the first dimension 392 is about 6 millimeters. Additionally, the second dimension 394 may be no greater than 40 millimeters in one example and no greater than 35 millimeters in another example. In particular, the second dimension 394 may be about 31 millimeters in one example. The area of the actuator opening 355 may be no greater than 400 square millimeters in one example, no greater than 280 square millimeters in one example, and no greater than 200 square millimeters in another example.

Returning briefly to FIG. 9, in some aspects, the actuator opening 355 is shaped and sized to receive a portion of a tongue 412 on a vehicle safety belt 410. As such, in addition to the example dimensions of the opening 355 provided herein, the actuator opening 355 may have a generally rectangular shape. For example, the actuator opening 355 may have at least a first edge (e.g., top edge) and a second edge (e.g., bottom edge) that are straight and substantially parallel to one another while a third edge (e.g., right edge) and a fourth edge (e.g., left edge) may be generally straight and substantially parallel to one another. In this way, the vehicle safety belt 410, which may be nearby when installing and uninstalling the car seat 100, may be used as a tool to unlock the locking elements. An end of the tongue 412 that faces away from the tether 414 of the safety belt 410 may be inserted into the actuator opening 355 to apply a force to the press portion 360 for unlocking the seat shell 200 from the base 300.

The press portion 360 of the actuator 350 may include a channel 362 defined by a first side wall 364 and a second side wall 366 that both extend from the opening 355 towards a back part 368 of the press portion 360 upon which force is applied. The channel 362 may have a length of at least 5 millimeters or at least 7 millimeters in another example. In this way, the back part 368 may be offset from the actuator opening 355, further reducing the risk of the press portion 360 from being inadvertently pressed.

Additionally, in some aspects, the channel 362 may taper inwards, or become narrower from the opening 355 to the back part 368. For example, the channel 362 may be defined by a first side wall 364 and a second side wall 366 and the distance between the first and second side walls 364 and 366 may decrease as the channel extends from the opening 355 to the back part 368. This tapered opening may help guide a tool, such as vehicle belt tongue 412, to the back part 368 so that force is applied to the correct part of the press portion 360 for triggering the actuator 350.

The actuator 350 extends between a first end 352 defined by the arm 358 and a second end 354 opposite the first end 352. In some aspects, the second end 354 is defined by the press portion 360. In other examples, such as the one depicted in FIGS. 8 and 9, the actuator 350 further comprises an actuator locking portion 380 that defines the second end 354 of the actuator. In these examples, the press portion 360 may be arranged between the actuator locking portion 380 and the arm 358.

The actuator locking portion 380 may be part of a mechanism that locks the actuator into an open position. Particularly, as previously described, the base 300 may include a biasing element, such as coil spring 340, that biases the locking elements (e.g., first and second hooks 322 and 324) on the base 300 towards the locked position. In this way, when a force is no longer applied to the actuator 350, the locking elements will automatically return to the locked position. However, it may be desirable to keep the locking mechanism in an unlocked state for additional time to allow the user time to fully remove the seat shell 200 from the base 300 without interference from the locking elements. This may be particularly true for embodiments where the actuator 350 is configured to be used with a tool other than a user's hand; in other words, when a user actuates the actuator 350 using a tool, such as a vehicle belt tongue 412, the user may desire for the locking mechanism to stay in the unlocked position after the tool is removed so that a user can uncouple the seat shell 200 from the base 300 without continuing to engage the actuator 350 with the tool.

FIGS. 11A and 11B depict partial perspective views of the base 300 with some parts removed to show an example actuator locking mechanism within the base 300. FIG. 11A shows the actuator locking mechanism in an unlocked state and FIG. 11B shows the mechanism in a locked state. FIG. 12 depicts a partial cross-sectional view of the actuator locking mechanism when the seat shell 200 is positioned within the receiving cavity 310 of the base 300.

The example actuator locking mechanism depicted in FIGS. 11A, 11B, and 12 include the actuator locking portion 380 of the actuator 350 and an actuator locking arm 370 in the base 300. The actuator locking arm 370 interacts with a recess, such as recess 240 or 242, on the bottom side 213 of the seat shell 200. In example aspects, a first end 371 of the actuator locking arm 370 engages with the actuator locking portion 380 of the actuator 350 while the second end 373 of the actuator locking arm 370 engages with the recess 240 or 242 of the seat shell 200. Between the first end 371 and the second end 373, the actuator locking arm 370 may have a pivot point 386 about which the actuator locking arm 370 pivots so that when the first end 371 is pivoted downward, the second end 373 is pivoted upwards and vice versa.

The first end 371 of the actuator locking arm 370 includes a first segment 372 and a second segment 374. Together, the first segment 372 and the second segment 374 may form a hook-like structure to engage with the actuator 350. When the actuator locking mechanism is disengaged (as shown in FIG. 11A), the first segment 372 may be positioned above the actuator locking portion 380 and extend in a generally downward direction so that the first segment 372 extends towards a top surface 384 of the actuator locking portion 380. The second segment 374 may extend away from the actuator 350 from a top end of the first segment 372.

The actuator locking arm 370 may be biased (e.g., with a biasing element like a spring), towards pivoting the first end 371 downward such that the first segment 372 is pushed towards the top surface 384 of the actuator locking portion 380. In some aspects, the first segment 372 is urged to push against the top surface 384. In this way, the top surface 384 of the actuator locking portion 380 may act to block further downward movement of the first end 371 of the actuator locking arm 370. However, when the press portion 360 of the actuator 350 is pushed inwards (away from the forward end 306), the actuator locking portion 380 may also be pushed inwards to a position where the top surface 384 of the actuator locking portion 380 is no long blocking downward movement of the first end 371 of the actuator locking arm 370. As a result, the first segment 372 of the actuator locking arm 370 may move downwards in front of an outer-facing surface 382 (which is a front-facing surface in this example) of the actuator locking portion 380. While the first segment 372 remains pushed down in front of the actuator locking portion 380, the actuator 350 remains in the actuated position and, therefore, the locking elements (e.g., the first and second hooks 322 and 324) remain in the unlocked position.

When the first end 371 of the actuator locking arm 370 pivots downward to lock the actuator 350 into an open position, the second end 373 of the actuator locking arm 370 pivots upwards. As such, the first end 371 may only be able to lock the actuator 350 in place when the second end 373 of the actuator locking arm 370 is able to move upwards. The second end 373 of the actuator locking arm 370 may include a third segment 376 extending upwards towards the seat shell 200 and a fourth segment 378 extending from the bottom of the third segment 376 towards the forward end 306 of the base to connect with the rest of the segments. The top of the third segment 376 of the actuator locking arm 370 may be configured to abut the bottom side 213 of the seat shell 200 when the seat shell 200 is positioned within the receiving cavity 310 of the base 300. The seat shell 200 interferes with the third segment 376 from being able to pivot upwards except when the third segment 376 is aligned with one of the recesses 240 and 242 in the seat shell 200. When the seat shell 200 is rotated so that one of the recesses 240 or 242 is positioned above the third segment 376, the actuator locking arm 370 may be pivoted so that the second end 373 moves upward and the first end 371 moves downward to lock the actuator 350 in place. The cross-sectional view of FIG. 12 shows the second end 373 of the actuator locking arm 370 engaged within a recess 240.

The locations of the recesses 240 or 242 may correspond with certain positions of the seat shell 200. As seen in FIG. 3B, recess 240 is generally positioned in front of the central portion of the bottom side 213 of the seat shell 200 and recess 242 is generally positioned behind the central portion. Additionally, example embodiments of the actuator locking arm 370 position the second end 373 of the arm towards a side (e.g., a left side) of the projection 320 in the center of the receiving cavity 310. In this way, the second end 373 (and more particularly, the third segment 376) aligns with recess 240 when the seat shell 200 is rotated to face the left side and aligns with recess 242 when the seat shell 200 is rotated to face the right side. The second end 373 does not align with either recess 240 or 242 when the seat shell 200 is rotated to a forward-facing position or a rear-facing position, which are the positions for vehicle travel. In this way, the positions of the second end 373 of the actuator locking arm 370 and the recesses 240 and 242 may be intended to prevent the locking mechanism from being kept in the unlock position via the actuator locking arm unless the seat shell 200 is rotated to a non-use position, such as one of the side intermediate positions.

The actuator 350 may be released from the actuator locking arm 370 when the actuator locking arm 370 pivots so that the first end 371 moves upwards and is no longer creating interference with the outer-facing surface 382 of the actuator locking portion 380. This movement may be triggered when the second end 373 of the actuator locking arm 370 is pushed downwards. After a seat shell 200 is unlocked and removed from the base 300, the seat shell 200 may be later placed back in the receiving cavity 310 for use again. If the seat shell 200 is placed on the base 300 in an orientation so that neither recess 240 nor recess 242 aligns with the second end 373 of the actuator locking arm 370, the bottom surface of the seat shell 200 will push down the second end 373, causing the first end 371 of the actuator locking arm 370 to pivot upwards and unlock the actuator 350, which in turn allows the locking mechanism (e.g., the first and second hooks 322 and 324) to return to a locked position to lock the seat shell 200 with the base 300. In some examples, the seat shell 200 may be positioned back on the base 300 so that the second end 373 of the actuator locking arm 370 does align with one of the recesses 240 or 242 in the seat shell. In this instance, when a user rotates the seat shell 200 towards a use position, the force of the user's rotation will push the second end 373 out of the recess 240 or 242, and interference with the seat shell 200 will cause the actuator locking arm 370 to pivot so that the actuator 350 is unlocked and the locking mechanism for the seat shell 200 and the base 300 becomes engaged.

The following clauses represent example embodiments of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.

Clause 1. A car seat comprising: a base having a receiving portion; a seat shell being rotatable relative to the base within the receiving portion; a lock for securing the seat shell to the base, wherein the seat shell is not removable from the base when the lock is in a lock configuration and is removable from the base when the lock is in an unlock configuration; an actuator for changing the lock from the lock configuration to the unlock configuration; and an actuator opening in an outer-facing surface of one of the base or the seat shell, the actuator opening exposing a press portion of the actuator and being sized to receive at least a first end of a tongue of a vehicle safety belt for applying force to the press portion.

Clause 2: The car seat of clause 1, wherein the actuator opening has a width that is about 31 millimeters.

Clause 3: The car seat of any of clauses 1-2, wherein the actuator opening has a height that is less than about 10 millimeters.

Clause 4: The car seat of any of clauses 1-3, further comprising a channel in the one of the base or the seat shell, the channel tapering inward from the actuator opening towards the press portion of the actuator.

Clause 5: The car seat of any of clauses 1-4, wherein the actuator opening is in the base.

Clause 6: The car seat of any of clauses 1-5, wherein the actuator opening has top straight edge and a bottom straight edge.

Clause 7: A car seat comprising: a seat shell comprising: a seat bottom, and a seat back extending upwardly away from the seat bottom, and a base including a receiving portion that interfaces with a lower side of the seat shell, the base including one or more engagement members at a central area of the receiving portion and movable between a locking position where the seat shell is secured to the receiving portion of the base and an unlocking position where the seat shell is removable from the base, wherein when the one or more engagement members are in the locking position, the seat shell is rotatable relative to the base, wherein in the locking position, the one or more engagement members are engaged with the seat shell through one or more lock openings on a lower side of the seat bottom, and in the unlocking position, the one or more engagement members are disengaged from the seat shell.

Clause 8: The car seat of clause 7, wherein the one or more engagement members comprises a first hook and a second hook.

Clause 9: The car seat of clause 8, wherein the one or more lock openings comprises a single lock opening defined by an opening edge, the single lock opening configured to receive the first hook and the second hook together, wherein when in the locking position, the first hook engages with a first portion of the opening edge and the second hook engages with a second portion of the opening edge.

Clause 10: The car seat of clause 9, wherein the first portion of the opening edge is opposite the second portion.

Clause 11: The car seat of any of clauses 7-10, wherein the base comprises an actuator for moving the one or more engagement members between the locking position and the unlocking position, the actuator being exposed through an actuator opening in an exterior surface of the base, the size of the actuator being no greater than 280 square millimeters.

Clause 12: The car seat of clause 11, wherein the actuator comprises a press button.

Clause 13: The car seat of clause 12, wherein the actuator comprises a first end comprising the press button and a second end, wherein the actuator is pivotable about a pivot point between the first end and the second end, and wherein a connector is secured to the second end of the actuator and, upon depression of the press button, pulls the one or more engagement members to disengage from the seat shell.

Clause 14: The car seat of clause 13, wherein a lower side of the seat shell includes a first recess and second recess, and the base further comprises an actuator locking arm having a first end adjacent to the first end of the actuator, wherein when the seat shell is rotated to a first position, the first recess aligns with a second end of the actuator locking arm and when the seat shell is rotated to a second position, the second recess aligns with the second end of the actuator locking arm, wherein when the second end of the actuator locking arm aligns with either the first recess or the second recess, the first end of the actuator locking arm is movable to block the first end of the actuator from moving out of an unlock position.

Clause 15: A car seat comprising: a base having a receiving portion; a seat shell being rotatable relative to the base within the receiving portion; a lock for securing the seat shell to the base, wherein the seat shell is not removable from the base when the lock is in a lock configuration and is removable from the base when the lock is in an unlock configuration; and an actuator for changing the lock from the lock configuration to the unlock configuration, the actuator movable from a lock position corresponding to the lock configuration and an unlock position corresponding to the unlock configuration; and an actuator locking arm having a first end, a second end, and a pivot point between the first end and the second end, the second end aligning with a recess in one of the seat shell or the base when the seat shell is rotated to a first position, wherein when the actuator moves to the unlock position and the second end of the actuator locking arm aligns with the recess, the actuator locking arm pivots until the first end interferes with the actuator moving back to the lock position.

Clause 16: The car seat of clause 15, wherein the base comprises the actuator and the actuator locking arm, and the seat shell comprises the recess.

Clause 17: The car seat of clause 16, wherein the seat shell comprises a second recess that is aligned with the second end of the actuator locking arm when the seat shell is rotated to a second position, wherein when the actuator moves to the unlock position and the second end aligns with the second recess, the actuator locking arm pivots until the first end interferes with the actuator moving back to the lock position.

Clause 18: The car seat of any of clauses 15-17, wherein the first position of the seat shell is between a forward-facing position and a rearward-facing position.

Clause 19: The car seat of any of clauses 15-18, wherein the one of the base or the seat shell comprises an actuator opening that exposes a portion of the actuator, the size of the actuator opening being no greater than 280 square millimeters.

Clause 20: The car seat of any of clauses 15-19, wherein the actuator comprises a press button; and when the actuator is pressed inward to the unlock position and the second end of the actuator locking arm aligns with the recess, the first end of the actuator locking arm is moved outside of an outer-facing surface of the actuator to block the actuator from moving outward to the lock position.

Clause 21: A car seat comprising: a base having a receiving portion; a seat shell being rotatable relative to the base within the receiving portion; a lock for securing the seat shell to the base, wherein the seat shell is not removable from the base when the lock is in a lock configuration and is removable from the base when the lock is in an unlock configuration; an actuator for changing the lock from the lock configuration to the unlock configuration; and an actuator opening in an outer-facing surface of one of the base or the seat shell, the actuator opening exposing a portion of the actuator, the size of the actuator opening being no greater than 280 square millimeters.

Clause 22: The car seat of clause 21, comprising a channel in the one of the base or the seat shell, the channel extending a distance between the actuator opening and the portion of the actuator so that the portion of the actuator is offset from the actuator opening.

Clause 23: The car seat of clause 22, wherein the portion of the actuator exposed through the actuator opening is a press portion, wherein the actuator is moved upon pressing the press portion.

Clause 24: The car seat of clause 23, wherein the channel tapers inwards from the actuator opening towards the press portion of the actuator.

Clause 25: The car seat of any of clauses 21-24, wherein the actuator opening has a first dimension that is no greater than 40 millimeters.

Clause 26: The car seat of clause 25, wherein the first dimension is about 31 millimeters.

Clause 27: The car seat of any of clauses 21-26, wherein the actuator opening is in the base.

Clause 28: The car seat of clause 27, wherein the receiving portion of the base includes a projection that is received within an opening on a lower side of the seat shell when the seat shell is coupled to the base, wherein the lock comprises a hook on the projection that extends at least partially through the opening on the lower side of the seat shell to engage with the seat shell when the lock is in the lock configuration.

While particular exemplary embodiments have been described, it is not intended that the claims be limited thereto, as it is intended that the claims be as broad in scope as the art will allow and that the specification be read likewise. That is, the foregoing description of specific embodiments will so fully reveal the general nature of the disclosure that others may, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It will be appreciated by those of ordinary skill in the art that the components, method steps, and materials illustrated above may be varied by substitution of equivalent components, steps, and materials capable of performing the same functions. It will also be appreciated by one of ordinary skill in the art that sizes and strengths of the components may be scaled up or down as required for specific purposes. The claims hereof are intended to encompass all such equivalent components, method steps and scales.

What is claimed is:

1. A car seat comprising:
a base having a receiving portion;
a seat shell being rotatable relative to the base within the receiving portion;
a lock for securing the seat shell to the base, wherein the seat shell is not removable from the base when the lock is in a lock configuration and is removable from the base when the lock is in an unlock configuration;
an actuator for changing the lock from the lock configuration to the unlock configuration; and
an actuator opening in an outer-facing surface of one of the base or the seat shell, the actuator opening exposing a press portion of the actuator and being sized to receive at least a first end of a tongue of a vehicle safety belt for applying force to the press portion.

2. The car seat of claim 1, wherein the actuator opening has a width that is about 31 millimeters.

3. The car seat of claim 1, wherein the actuator opening has a height that is less than about 10 millimeters.

4. The car seat of claim 1, further comprising a channel in the one of the base or the seat shell, the channel tapering inward from the actuator opening towards the press portion of the actuator.

5. The car seat of claim 1, wherein the actuator opening is in the base.

6. The car seat of claim 1, wherein the actuator opening has top straight edge and bottom straight edge.

7. A car seat comprising:
a seat shell comprising:
a seat bottom, and
a seat back extending upwardly away from the seat bottom; and
a base including a receiving portion that interfaces with a lower side of the seat shell, the base including one or more engagement members at a central area of the receiving portion and movable between a locking position where the seat shell is secured to the receiving portion of the base and an unlocking position where the seat shell is removable from the base, wherein when the one or more engagement members are in the locking position, the seat shell is rotatable relative to the base,
wherein in the locking position, the one or more engagement members are engaged with the seat shell through one or more lock openings on a lower side of the seat bottom, and in the unlocking position, the one or more engagement members are disengaged from the seat shell.

8. The car seat of claim 7, wherein the one or more engagement members comprises a first hook and a second hook.

9. The car seat of claim 8, wherein the one or more lock openings comprises a single lock opening defined by an opening edge, the single lock opening configured to receive the first hook and the second hook together, wherein when in the locking position, the first hook engages with a first portion of the opening edge, and the second hook engages with a second portion of the opening edge.

10. The car seat of claim 9, wherein the first portion of the opening edge is opposite the second portion.

11. The car seat of claim 7, wherein the base comprises an actuator for moving the one or more engagement members between the locking position and the unlocking position, the actuator being exposed through an actuator opening in an exterior surface of the base, the size of the actuator being no greater than 280 square millimeters.

12. The car seat of claim 11, wherein the actuator comprises a press button.

13. The car seat of claim 12, wherein the actuator comprises a first end comprising the press button and a second end, wherein the actuator is pivotable about a pivot point between the first end and the second end, and wherein a connector is secured to the second end of the actuator and, upon depression of the press button, pulls the one or more engagement members to disengage from the seat shell.

14. The car seat of claim 13, wherein a lower side of the seat shell includes a first recess and second recess, and the base further comprises an actuator locking arm having a first end adjacent to the first end of the actuator, wherein when the seat shell is rotated to a first position, the first recess aligns with a second end of the actuator locking arm, and when the seat shell is rotated to a second position, the second recess aligns with the second end of the actuator locking arm, wherein when the second end of the actuator locking arm aligns with either the first recess or the second recess, the first end of the actuator locking arm is movable to block the first end of the actuator from moving out of an unlock position.

15. A car seat comprising:
a base having a receiving portion;
a seat shell being rotatable relative to the base within the receiving portion;
a lock for securing the seat shell to the base, wherein the seat shell is not removable from the base when the lock is in a lock configuration and is removable from the base when the lock is in an unlock configuration;
an actuator for changing the lock from the lock configuration to the unlock configuration, the actuator movable from a lock position corresponding to the lock configuration and an unlock position corresponding to the unlock configuration; and
an actuator locking arm having a first end, a second end, and a pivot point between the first end and the second end, the second end aligning with a recess in one of the seat shell or the base when the seat shell is rotated to a first position, wherein when the actuator moves to the unlock position and the second end of the actuator locking arm aligns with the recess, the actuator locking arm pivots until the first end interferes with the actuator moving back to the lock position.

16. The car seat of claim 15, wherein the base comprises the actuator and the actuator locking arm and the seat shell comprises the recess.

17. The car seat of claim 16, wherein the seat shell comprises a second recess that is aligned with the second end of the actuator locking arm when the seat shell is rotated to a second position, wherein when the actuator moves to the unlock position and the second end aligns with the second recess, the actuator locking arm pivots until the first end interferes with the actuator moving back to the lock position.

18. The car seat of claim 15, wherein the first position of the seat shell is between a forward-facing position and a rearward-facing position.

19. The car seat of claim 15, wherein the one of the base or the seat shell comprises an actuator opening that exposes a portion of the actuator, the size of the actuator opening being no greater than 280 square millimeters.

20. The car seat of claim 15, wherein the actuator comprises a press button; and when the actuator is pressed inward to the unlock position and the second end of the actuator locking arm aligns with the recess, the first end of the actuator locking arm is moved outside of an outer-facing surface of the actuator to block the actuator from moving outward to the lock position.
